(19) United States
(12) Patent Application Publication
(10) Pub. No.: US 2010/0276178 A1
(43) Pub. Date: Nov. 4, 2010

(54) PROFILED INSULATION AND METHOD FOR MAKING THE SAME

(76) Inventors: Joshua Keller, Mechanicsburg, PA (US); Greg Heffner, Denver, PA (US)

Correspondence Address: SOFER & HAROUN LLP., 317 MADISON AVENUE, SUITE 910, NEW YORK, NY, 10017, US

(21) Appl. No.: 12/432,392

(22) Filed: Apr. 29, 2009

(51) Int. Cl. H01B 11/02; H01B 3/30

(52) U.S. Cl. 174/113 C; 174/110 SR

(57) ABSTRACT

A wire, having a conductor and an insulation, extruded onto the conductor. The insulation has a plurality of alternating plateaus and valleys thrilling a profile along the outer circumference, where a circumference ratio of an outer circumference of the insulation at the full thickness of the plateaus relative to the portion of the outer circumference of the insulation that is at the reduced thickness of valleys is substantially 1.5 or greater.

### BACKGROUND

1. Field of Invention

The present application relates to the field of cables and cable production. More particularly, the present application relates to a profiled insulation for cables and method for making the same.

2. Description of Related Art

Copper cables are used for a variety of tasks, such as power transmission and signal transmission. In signal transmission tasks, the choice of insulation is of particular concern, for example, twisted pairs of copper conductors used in data cables e.g., LAN (Local Area Network) cables) must meet certain fire safety standards and be cost effective, while minimizing signal degradation. Such signal degradation may be caused by factors such as interference with adjacent conductors, and inductance with the insulation.

Thus, in developing copper wire signal cables, often having, multiple twisted pairs of copper wire within the same jacket, there are the competing concerns of minimizing cost while maximizing signal strength and clarity.

In order for the cable to function properly, the impedance measurement between the two copper conductors of a twisted pair must be precisely maintained. This is achieved by insulating the conductor with a dielectric material. However, the dielectric material has a negative impact on the electrical signal and contributes to signal losses as well as other undesirable electrical phenomena. In addition, this dielectric material adds cost to the cable construction and often has a negative impact on cable fire performance, such as in UL™ (Underwriters Laboratories) testing. Thus, it is desirable to find was to reduce the amount of dielectric material in proximity to the copper conductor without affecting the impedance between the two copper conductors forming the twisted pair.

Several approaches have been taken in the past to reduce the amount of dielectric material in proximity to the copper conductors without reducing the impedance of the twisted pair made from said copper conductors. For example, some manufacturers have replaced typical copper wire dielectric insulation with a foamed dielectric insulation which adds a gas component to the insulation. This yields a reduction in the amount of dielectric material necessary to maintain the impedance of the twisted pair. It is known that the typical gases used for foam dielectric materials have a dielectric constant close to 1 (most desirable), whereas known dielectric materials without the gas component have a dielectric constant substantially greater than 1, so this approach would appear, at first glance, to aid in resolving the concerns. However, this method not only greatly increases the complexity of the extrusion process, but often requires additional manufacturing equipment. It is also mach more difficult to manufacture a data communications cable with good electrical properties using this type of process.

Another method to reduce the amount of insulation while simultaneously maintaining the impedance between a twisted pair of conductors is to add openings (air or inert gas filled) within the insulation itself. However, prior art methods for producing such insulation with longitudinal air/gas openings have either completely failed due to extrusion designs that do not produce the intended results or have otherwise produced ineffective results due to inconsistencies in the stable production of the openings.

Yet another manner for maintaining the impedance between as twisted pair of conductors while reducing the amount of insulation material used within a signal cable is to use what is termed “profiled” insulation. Profiled insulation refers to an insulation that is provided around a copper wire conductor, the cross-section of which is other than substantially circular. Such examples of profiled insulation may include saw tooth structures or other similar designs intended to both separate the conductors from one another while using less insulation than to solid insulator of similar diameter but yielding the same impedance between twisted pairs of conductors. One Example, of this type of insulation may be found in pending U.S. Application No. 2008/0296042.

However, even with this method there are a number of drawbacks. First, it is difficult to achieve the desired shapes of the contoured insulation. Many of the desired insulation shapes are either too difficult or impossible to make under typical copper wire insulation extrusion line conditions. Even if a particular design can be made for the insulation, they are typically generated in a manner that provides an inconsistent product.

Moreover, due to such extrusion constraints, it is difficult to provide a product whose final shape is stable over a given length of cable so that the electronic property measurements remain consistent. For example, some earlier designs of profiled insulation, while working to reduce material and dielectric interference, sometimes result in the copper wires in a particular pair moving closer and farther from one another along a length of cable as the various profile shapes of one conductor interweave/nest within one another. See for example, FIG. 1 showing a prior art twisted pair having profiled insulation, where the profile ridges are “nested” within one another, causing the copper conductors to be closer to one another than desired.

### OBJECTS AND SUMMARY

The present invention looks to overcome the drawbacks associated with the prior art and provides a profiled insulation and method for making the same. The profiled insulation is dimensioned so as to produce the optimum results, balancing the need to achieve a desired impedance value between a twisted pair of copper conductors within a cable, with the need for reduced amounts of insulation to prevent inductive loss. Additionally, the profiled insulation is of such dimension that it can be manufactured in a cost effective (reduced total insulation per length of cable) and commercially reproducible manner (i.e. consistent electrical properties) under copper wire line extrusion, while maintaining consistent electrical transmission properties along the length of the cable.

To this end, the present invention provides for a wire, having a conductor and an insulation, extruded onto the conductor. The insulation has a plurality of alternating plateaus and valleys forming is profile along the outer circumference, where a circumference ratio of an outer circumference of the insulation at the full thickness of the plateaus relative to the portion of the outer circumference of the insulation that is at the reduced thickness of valleys is substantially 1.5 or greater.

### BRIEF DESCRIPTION OF THE DRAWINGS

FIG. 1 is an illustration of a twisted pair having profiled insulation according to the prior art;

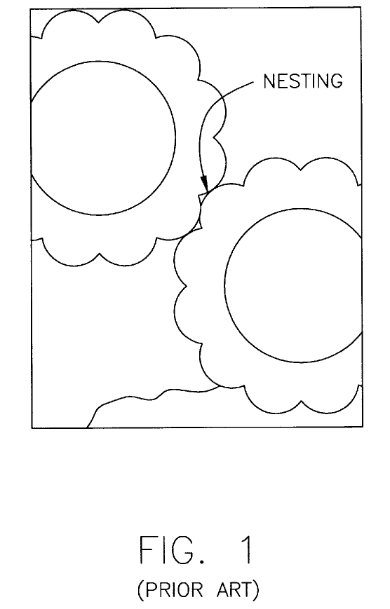

FIG. 2 is an illustration of an extrusion die according to one embodiment;

FIG. 3 shows a profiled insulation achieved using the die of FIG. 2 in accordance with one embodiment;

FIG. 4 is a schematic diagram of the profiled insulation of FIG. 3;

FIG. 5 is an illustration of a twisted pair having profiled insulation according to FIG. 3;

FIG. 6 illustrates a LAN cable having four twisted pairs, two of which have the profiled insulation of FIG. 3, in accordance with one embodiment;

FIG. 7 illustrates a LAN cable having four twisted pairs surrounding a cross filler, all of which have the profiled insulation of FIG. 3, in accordance with one embodiment;

FIG. 8 is a die for forming profiled insulation in accordance with another embodiment;

FIG. 9 is a profiled insulation achieved using the die of FIG. 8 in accordance with one embodiment;

FIG. 10 is an illustration of a twisted pair having profiled insulation according to FIG. 9;

FIGS. 11 and 11A show a die for extrusion of profiled insulation under pressure extrusion in accordance with another embodiment.

### DETAILED DESCRIPTION

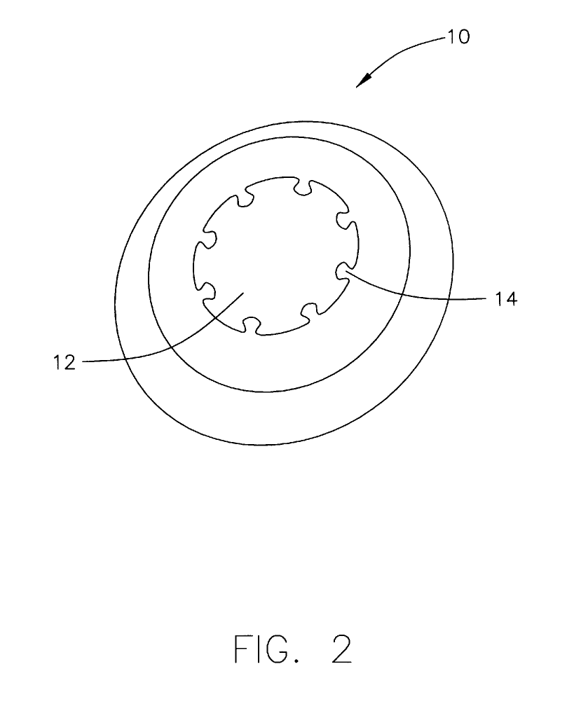

In one embodiment. FIG. 2 illustrates an extrusion die H) used for extrusion of profiled insulation onto conductors for use in wires, such as telecommunications/electronic signal wires. Extrusion die 10 is utilized in a typical extrusion line format, whereby a conductor wire is drawn through die 10, onto which the melted insulator/polymer is applied. For the purposes of illustration, the present application contemplates that the conductors being coated are wire conductors, such as copper wires, and the insulation is FEP (Fluorinated Ethylene Propylene), for use in twisted pair communication wires used in LAN (Local Area Network) cables. However, it is understood that the embodiments described herein are equally applicable to other polymer insulations, such as MFA, PVC, and EFEP insulation as well as both drawn-down type and pressure extrusion (using PE or PP for example, as described later in the specification).

It another embodiment, it is noted that the profiled insulation described herein is illustrated by way of example as an insulation applied directly to a conductor. However, this is not intended to be limiting in any way. It is contemplated that similarly constructed profiled insulation may be used in part or in whole on outer cable jacketing as well as extruded cross filler items as well.

As shown in FIG. 2, die 10 includes an opening 12 through which the conductor and molten polymer flow during extrusion. It is noted, that FIG. 2 only shows the die 10 itself, which ultimately forms the dimensions of the outer circumference of the eventual extruded insulation. The extrusion tip, which would fit through die 10, supporting the conductor and forming the inner circumference of the insulation (against the conductor), is not shown. In the present arrangement, the tip used to form the insulations as described below is a typical extrusion tip used with draw-down type extrusion.

Opening 12 of die 10 includes a plurality of projections 14, disposed uniformly around the circumference of opening 12. In one arrangement, projections 14 are typically shortened projections that extend radially inward towards the center of opening 12. Each of the projections 14 are in the shape of a circular “knob” 16 at the end of a short tapered shank portion 18. In the arrangement shown in FIG. 2, eight evenly spaced projections 14 are used. However, it is noted that the number and spacing of projections 14 may be altered to accommodate different final insulation designs.

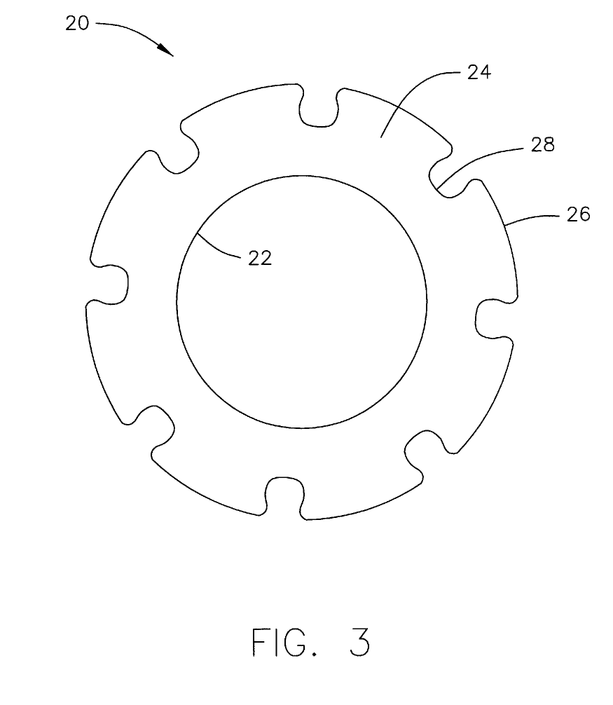

According to one arrangement, as shown in FIG. 3, insulation 20 is the resultant insulation produced by draw down extrusion using die 10 (shown with conductor removed). Insulation 20 has an inner circumference 22 which is adjacent to a conductor (shown and described later) and an outer “profiled” circumference 24. Outer circumference 24 of insulation 20 has periodically repeating plateaus 26 and valleys 28, the dimensions of which correlate to projections 14 of die 10. For example, valleys 28 on insulation 20 are formed during the extrusion process via, die 10 and correspond to the locations of projections 14 whereas plateaus 26 correlate to where the insulation passed between projections 14 directly against the inner circumference of opening 12 of die 10.

It is noted that FIG. 3 shows only seven valleys, by way of example, meaning it corresponds to an exemplary die 10 having seven projections 14. A sample insulation 20 extruded using die 10 as shown in FIG. 3, having, eight projections 14 (not shown) would have eight corresponding, valleys 28. Preferably, designs may include as few as three valleys 28 and as many as twenty five depending on the design.

It is also noted that projections 14 are illustrated as circular shaped, however this is by example only. Other shapes may be used for projections 14 to adjust the polymer reduction amount (cost savings) while maintaining stability no meshing of insulations within a given twisted pair).

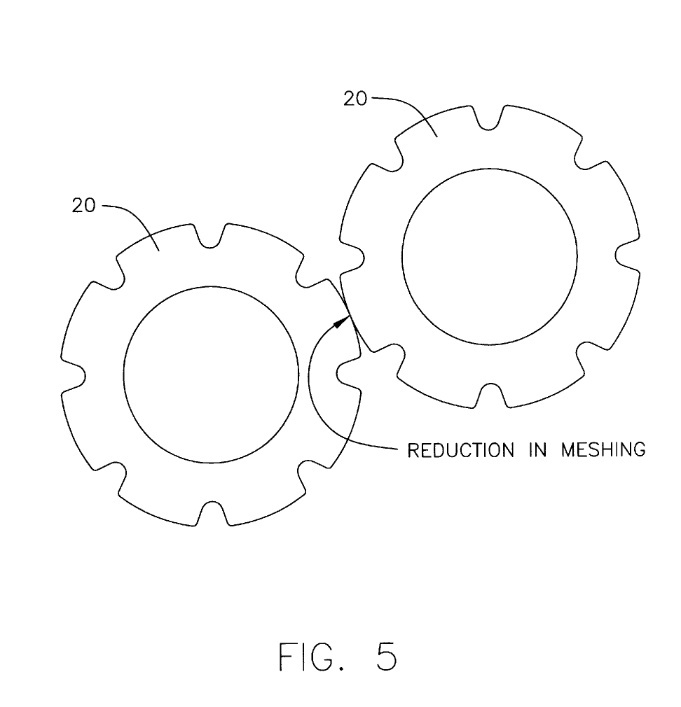

A schematic drawing of an insulation 20, having alternating plateaus 26 and valleys 28, shows the necessary measurements for determining the circumference ratio B/A, meaning the ratio of outer circumference 24 that is at the full thickness of plateaus 26 relative to the portion of outer circumference 24 that is at the reduced thickness of valleys 28 should be substantially 1.5 or greater. Using such a ratio for B/A, when two insulated wires are placed next to one another, each having such a profiled insulation 20, it will both simultaneously reduce the total amount of insulation 20 used, while preventing “meshing” of the two wires as shown in FIG. 5. This allows the electrical characteristics of the pair to remain substantially constant along the length of the pair.

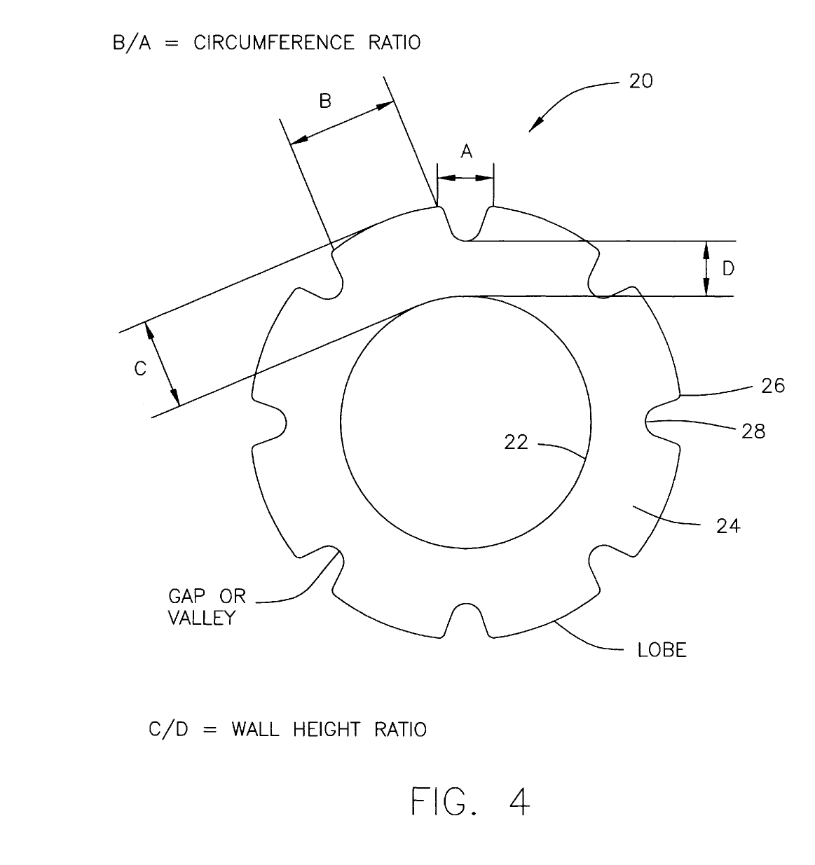

Also, shown in FIG. 4 is the ratio C/D giving the height from the inner circumference 22 to a plateau 26 (C) relative to the height from the inner circumference 22 to the top of a valley 28 (D). Preferably the CD ratio should be substantially 2.0 but not greater than 4.0. In one arrangement, the C/D ratio is preferably between 1.1 and 4.0 so as to maximize crush resistance of insulation 20 and to minimize spreading of the lobes (plateaus 26) under stress of the twisting operation (forming twisted pairs).

In one arrangement, the value of C/D should tend towards 1.1, and in most cases, does not exceed 2.0.

The following is an exemplary test data showing the results achieved with insulation 20 as described above.

For example, in a test a conductor is selected, such as a copper wire conductor having a 0.0224″ thickness, with an outer insulation 20 diameter of approximately 0.0386.″ This is achieved using an extrusion guider tip dimensioned at 0.200″ and an extrusion die having an opening of 0.364,″ with as draw down balance of substantially 1.03 and draw down ratio of substantially 85:1.

Using a the 10 as shown in FIG. 2, having projections 14 therein dimensioned according; to the above 13/A and C/D ratio ranges tactual test measurements A=0.004296″, B=0.01047″, C=0.007955, D=0.003913, translated into B/A=2.44 and C/D=2.03) a reduction in material of substantially 16.0% was achieved relative to a typical die of similar dimensions not having the same projections which would have otherwise resulted in a smooth outer surfaced insulation.

Thus, according to this arrangement, a substantial reduction in material can be achieved along any given length of insulation for a conductor wire, while simultaneously preventing meshing of insulation between two adjacent wires, such as in a twisted pair, as shown in FIG. 5.

In another arrangement, conductor size ranges for the above exemplary test may typically range between 0.018″ and 0.024.″ with outer insulation preferably ranging between 0.030″ and 0.045.″ Such dimensions of insulation would be made with an extrusion guider tip having a range of 0.100″ and 0.350″ and a die 10 having an opening 12 range of substantially 0.250″ and 0.550,″ employing draw balance ratios in the range of 0.95 and 1.05 and draw down ratios of 50:1 to 250:1. Adjustments within these ranges may result in material reduction between 5% and 35% and may be selected based on desired parameters, provided that the plateaus 26 and valleys 28 on resulting insulation 20 are such that they prevent nesting in paired arrangements as shown in FIG. 5.

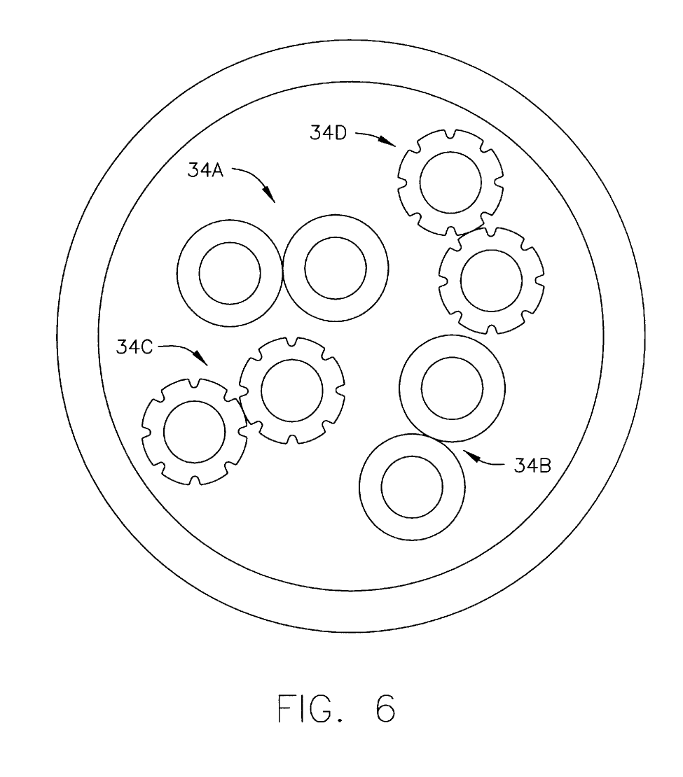

In one embodiment as shown in FIG. 6 a typical four-pair LAN cable 30 is shown, using wires having insulation 20 as described above, achieving CAT 6 compliance with reduced use of insulation. Cable 30 has a jacket 32, and four twisted pairs 34a-34d therein. In the present arrangement, two pairs 34a and 34h are made with typical insulated conductor wires, whereas two pairs 34c and 34d within jacket 30 include wires having profiled insulation 20.

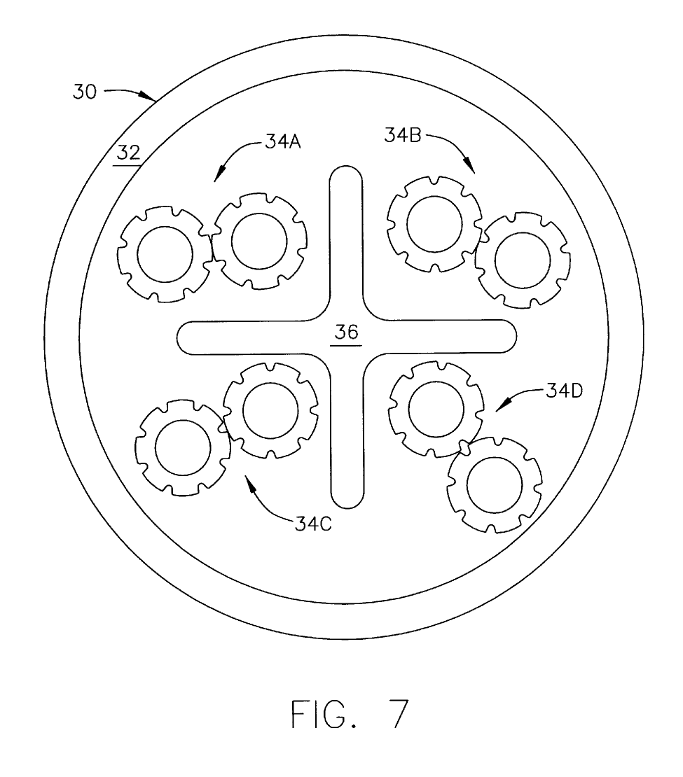

In another example of a IAN cable, illustrated in FIG. 7, cable 30 another typically arranged four-pair LAN cable 30 is shown, using wires having insulation 20 as described above, achieving CAT 6 compliance with reduced use of insulation. Cable 30 has a jacket 32, and four twisted pairs 34a-34d therein. In this arrangement, all four pairs 34a-34d include wires having profiled insulation 20 and a cross filler 36 is included to reduce internal cross-talk between pairs.

It is contemplated that other possible uses of profiled insulation 20 on twisted pair conductors may be used within LAN cables 30, to achieve various desired Category ratings, taking advantage of the reduced insulation usage on the conductors while still providing stable electrical characteristics along the pairs 34, thus allowing cable 30 to meet elevated category ratings, while using lesser amounts of polymer insulation.

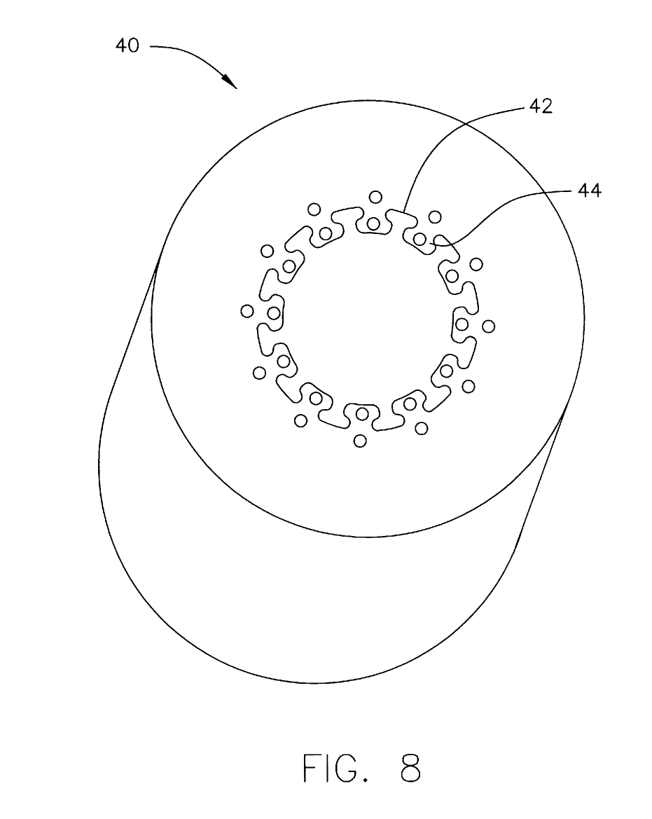

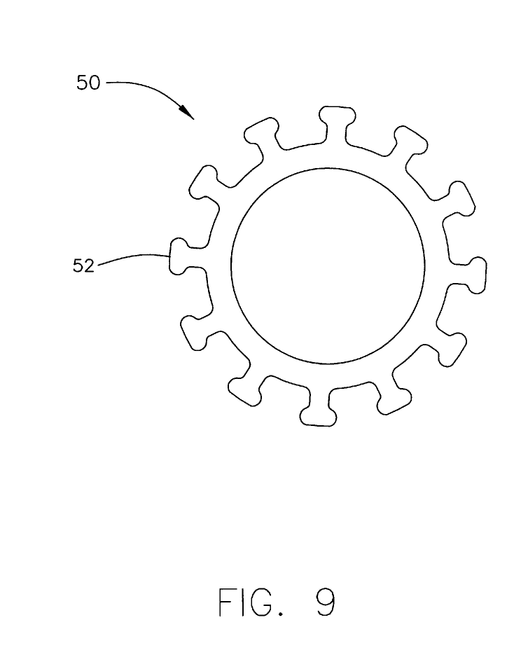

In another embodiment, as shown in FIG. 8, an alternative die 40 may be employed, also having an inner diameter 42 and projections 44. In this arrangement, projections 44 are dimensioned so as to provide an insulation 50 having successive T-shaped projections 52 disposed thereon as shown in FIG. 9. As with die 10 and insulation 20, the positions of the projections 44 correspond to the open spaces between T-shaped projections 52, owning to the projections 44 blocking the polymer flow during extrusion.

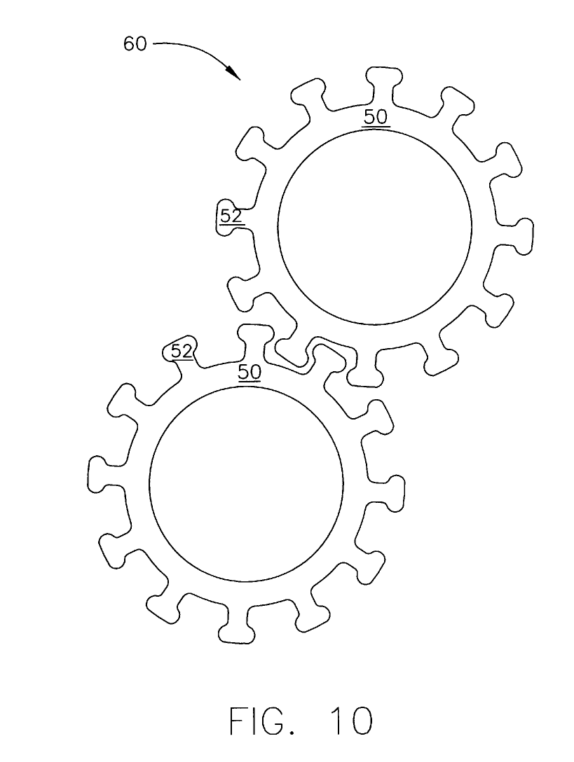

Such an insulation 50 when utilized in conjunction within a twisted pair arrangement 60 as shown in FIG. 10, will allow the various T-shaped projections 52 on opposing wires to intermesh within one another. Such an arrangement, may be useful in various cable designs, with pairs that are interlocked while in the cable, with the ability to be separated later, such as during a connectorization.

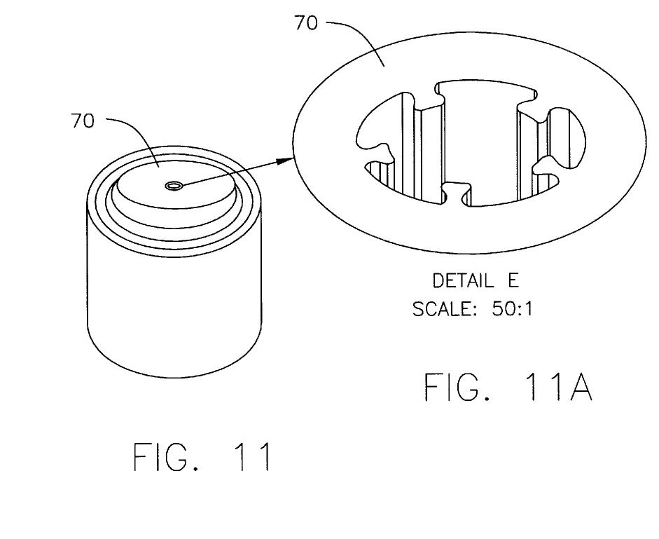

In another embodiment, as discussed above, the profiled insulation 20 may be produced using either PE or PP using pressure extrusion techniques. Pressure extrusion differs from draw down type extrusion in that insulation 20 is extruded under pressure, and exists the die in the same or nearly the same dimensions in which it will eventually cool. As such, the dimensions of a die, such as die 70, shown in FIGS. 11 and 11A (50× expanded view) are the same as the dimensions of a profiled insulation 20 that exists therefrom. By forming insulation 20 using pressure extrusion, it is possible to gain the same advantages discussed above, under higher extrusion line speeds using polymers that can handle such extrusion stresses.

While only certain features of the invention have been illustrated and described herein, ninny modifications, substitutions, changes or equivalents will now occur to those skilled in the art. It is therefore, to be understood that this application is intended to cover all such modifications and changes that fall within the true spirit of the invention.

What is claimed is:

1. A wire, said wire comprising:
a conductor; and
an insulation, extruded onto said conductor, said insulation having a plurality of alternating plateaus and valleys forming a profile along the outer circumference, wherein a circumference ratio of an outer circumference of said insulation at the full thickness of said plateaus relative to the portion of the outer circumference of the insulation that is at the reduced thickness of valleys is substantially 1.5 or greater.

2. The wire as claimed in claim 1, wherein said ratio of the height from the inner circumference to a plateau relative to the height from the inner circumference to the top of a valley is in the range of substantially 1.1 to 4.0.

3. The wire as claimed in claim 2, wherein said ratio of the height from the inner circumference to a plateau relative to the height from the inner circumference to the top of a valley is in the range of substantially in the range of 1.1 to 2.0.

4. The wire as claimed in claim 2, wherein said valleys in said insulation result in a material reduction of substantially 16% relative to a similarly dimensioned insulation without said valleys.

5. The wire as claimed in claim 2, wherein said insulation is extruded at a draw balance ratio substantially in the range of 0.95 and 1.05.

6. The wire as claimed in claim 2, wherein said insulation is extruded at a draw down ratios of 50:1 to 250:1.

7. The wire as claimed in claim 2, wherein a circumference ratio of an outer circumference of said insulation at the full thickness of said plateaus relative to the portion of the outer circumference of the insulation that is at the reduced thickness of valleys is substantially 2.44 and wherein said ratio of the height from the inner circumference to a plateau relative to the height from the inner circumference to the top of a valley is in the range of substantially 2.03.

8. The wire as claimed in claim 1, wherein said insulation is selected from the group consisting FEP, MFA, PVC, and EFEP.

9. The wire as claimed in claim 1, wherein said insulation is made of PE or PP under pressure extrusion conditions.

10. A twisted pair of wires comprising:
two wires constructed according to claim 1, wherein when a first wire of said two wires is placed next to a second wire of said two wires, said plateaus on said outer circumference do not nest within one another.

11. A LAN cable, said cable comprising:
at least one twisted pair according to claim 10, wherein said LAN cable meets CAT 6 specifications.

12. The cable according to claim 11, said cable further comprising to cross filler.

13. A LAN cable, said cable comprising:
a plurality of twisted pairs according to claim 10, wherein said LAN cable meets CAT 6 specifications.

14. The cable according to claim 13, said cable further comprising a cross filler.
